(19) United States
(12) Patent Application Publication
(10) Pub. No.: US 2006/0055910 A1
(43) Pub. Date: Mar. 16, 2006

(54) Exposure apparatus adapted to detect abnormal operating phenomenon

(76) Inventor: Jong-Haw Lee, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/190,013

(22) Filed: Jul. 27, 2005

(30) Foreign Application Priority Data
Aug. 27, 2004 (KR) 2004-67792

(51) Int. Cl. G03B 27/58; G03B 27/32

(52) U.S. Cl. 355/72; 355/77

(57) ABSTRACT

A wafer edge exposure apparatus and method of operation are disclosed. The apparatus includes an edge exposing device exposing an edge portion of a wafer loaded onto a rotatable support chuck under a body tube and an interlock generator generating an interlock signal stopping operation of the wafer edge exposure apparatus upon acoustically or optically detecting an abnormal phenomenon in relation to a wafer being processed and body tube.

### BACKGROUND OF THE INVENTION

1. Technical Field

The present invention relates to an apparatus for exposing a substrate such as a semiconductor wafer, a reticle, and a mask and, more particularly, to a wafer edge exposure apparatus.

This application claims the benefit of Korean Patent Application No. 10-2004-0067792, filed Aug. 27, 2004, the disclosure of which is hereby incorporated by reference in its entirety.

2. Discussion of Related Art

The typical sequence of processes used to manufacture semiconductor devices is a long and complicated one. Many individual semiconductor devices are manufactured on a single substrate. This substrate is normally provided in the form of a thin wafer of semiconductor material.

Most conventional process sequences used to manufacture semiconductor devices include multiple coating processes, during which a material layer is formed on the wafer using one or many coating techniques. Photoresist (e.g., a photosensitive material) layers are a common type of material layer formed by coating processes.

Once a photoresist layer is formed on a wafer, it is generally patterned in a patterning process. Conventional patterning processes may be divided into a photolithography process and an etching process. By use of a mask or reticle, the photolithography process forms a photoresist film pattern on a photoresist film covering an underlying material film. The etching process then selectively etches a material film using etchant applied to the photoresist film pattern.

Conventional photolithography processes may be further characterized by processes such as photoresist film lamination, bake, development, and rinsing. The photoresist film lamination is often performed by specialized spinner equipment adapted to coat a photoresist solution on a wafer using a spin-on coating technique.

Most spinner equipment includes a wafer edge exposure apparatus specifically adapted to ensure wafer edge exposure of peripheral portions of the wafer which may not be exposed during other (e.g., pattern-related) processes. Such peripheral portions are captured within a predetermined width or track around the wafer. Thus, the wafer edge exposure apparatus typically operates during or after a pattern formation exposure process to ensure exposure of portions of a photoresist layer covering outer portions of a wafer, such as the edge portion, so as to prevent portions of the photoresist film covering the edge portion of the wafer from becoming a particle source during subsequent processing. That is, the material characteristics of the photoresist covering the edge portion of the wafer are changed by the wafer edge exposure process to have the same characteristics as other portions of the photoresist layer undergoing pattern-related processes. In this manner, all portions of the photoresist layer may be effectively treated and removed from the wafer by a subsequent development process.

When the wafer is loaded by means of a clamp, after the photoresist coated at the edge part of the wafer is stuck to the clamp, it falls at other parts of the wafer, thereby contaminating a surface of the wafer. However, the wafer edge exposure prevents the aforementioned problems from being occurred, namely, prevents the surface of the wafer from being contaminated. Further, the wafer edge exposure prevents particles from being mass-produced due to the frictions between the wafer and other objects.

FIG. 1 is a schematic view illustrating a conventional wafer edge exposure apparatus. With reference to FIG. 1, a wafer edge exposure unit 10 and a lamp house 30 are connected to each other through an optical cable 20. A power supply 40 is connected to lamp house 30 and supplies the power necessary to operate the lamp. A mercury lamp is generally used as a light source in the wafer edge exposure apparatus.

FIG. 2 is a perspective view further illustrating the wafer edge exposure unit 10 of FIG. 1. Wafer edge exposure unit 10 generally comprises lens 13, a wafer edge exposing device 12, a body tube 14, a chuck 15, an illumination detector 16, a support wall 17, an illumination detector support member 18, an air device 19, a horizontal adjustment device 22.

Lens 13 receives light from lamp house 30 through optical cable 20, and transmits a focused version of the light on the edge portion of the wafer. Lens 13 is typically installed inside body tube 14. Body tube 14 couples optical cable 20 to wafer edge exposure unit 10 in an optically isolated manner to produce a shielded path for the light to-be-applied to the edge portion of a wafer 21.

Once wafer 21 is loaded onto chuck 15, the edge portion of the wafer will rotate under body tube 14 in order to be selectively exposed to the focused light. Wafer 21 rotates under body tube 14 in very close proximity in order to achieve minimal interference from external light sources and to ensure proper focus of the light on the edge portion of the wafer. In this regard, body tube may generally be vertically adjusted in relation to wafer 21.

Unfortunately, there are times when mechanical fatigue in one or more of these components, a wafer loading error by an operator, or similar problem results in the body tube making physical contact with the rotating wafer. This contact inevitably causes serious damage to the delicate surface of the wafer and materials layers formed thereon. Additionally, errant adjustment of body tube 14 may cause contact of body tube 14 with wafer 21 causing similar damage to material layers formed on the wafer.

### SUMMARY OF THE INVENTION

Embodiments of the present invention provide a wafer edge exposure apparatus including an interlock generator that eliminates or at least minimizes impact incidents between the body tube and wafer, thereby avoiding damage to the wafer.

For example, one embodiment provides a wafer edge exposure apparatus, comprising; an edge exposing device adapted to expose an edge portion of a wafer loaded onto a rotatable support chuck under a body tube, and an interlock generator adapted to detect phenomenon in relation to at least one of the wafer and body tube, and further adapted to generate an interlock signal stopping operation of the wafer edge exposure apparatus upon detecting an abnormal phenomenon.

The wafer edge exposure apparatus may further comprises an equipment drive section adapted to drive the support wafer and responsive to the interlock signal to halt operation.

The abnormal phenomenon may be a scratch in the surface of the wafer or friction noise associated with contact between the wafer and body tube.

In another embodiment, a method for monitoring abnormal operating phenomenon in a wafer edge exposure apparatus is provided. The method comprises; detecting abnormal phenomenon associated with a wafer loaded onto a support chuck under a body tube, and generating an interlock signal halting operation of the wafer edge exposure apparatus in response to a detected abnormal phenomenon.

### BRIEF DESCRIPTION OF THE DRAWINGS

Embodiments of the invention are described hereafter with reference to the attached drawings in which:

FIG. 1 is a schematic view showing a construction of a conventional wafer edge exposure apparatus;

FIG. 2 is a perspective view showing a schematic construction of a wafer edge exposure apparatus shown in FIG. 1;

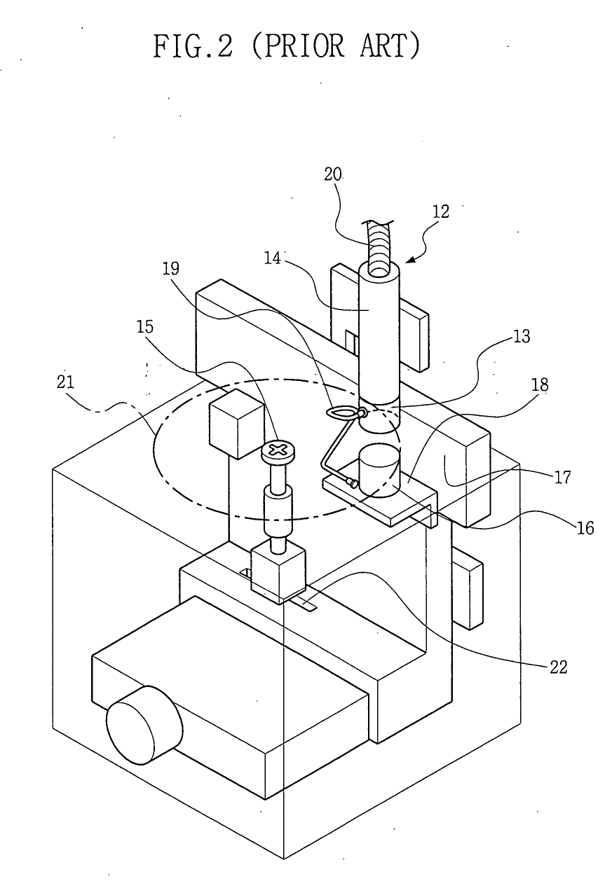

FIG. 3 is a perspective view showing a schematic construction of a wafer edge exposure unit in an exposure apparatus in accordance with an embodiment of the present invention;

FIG. 4 is a graph showing one example of a friction sound measured by the wafer edge exposure unit shown in FIG. 3;

FIG. 5 is a block diagram showing one example of a configuration of an interlock generator in the wafer edge exposure unit shown in FIG. 3;

FIG. 6 is a block diagram showing another example of a configuration of an interlock generator in the wafer edge exposure unit shown in FIG. 3; and

FIG. 7 is a flow chart showing a method of generating an interlock signal by the exposure apparatus of FIG. 3.

### DETAILED DESCRIPTION OF THE INVENTION

The present invention will now be described with reference to the accompanying drawings, in which preferred embodiments of the invention are shown. However, the invention should not be construed as limited to only the embodiments set forth herein. Rather, these embodiments are presented as teaching examples. In the drawings, like numbers refer to like elements.

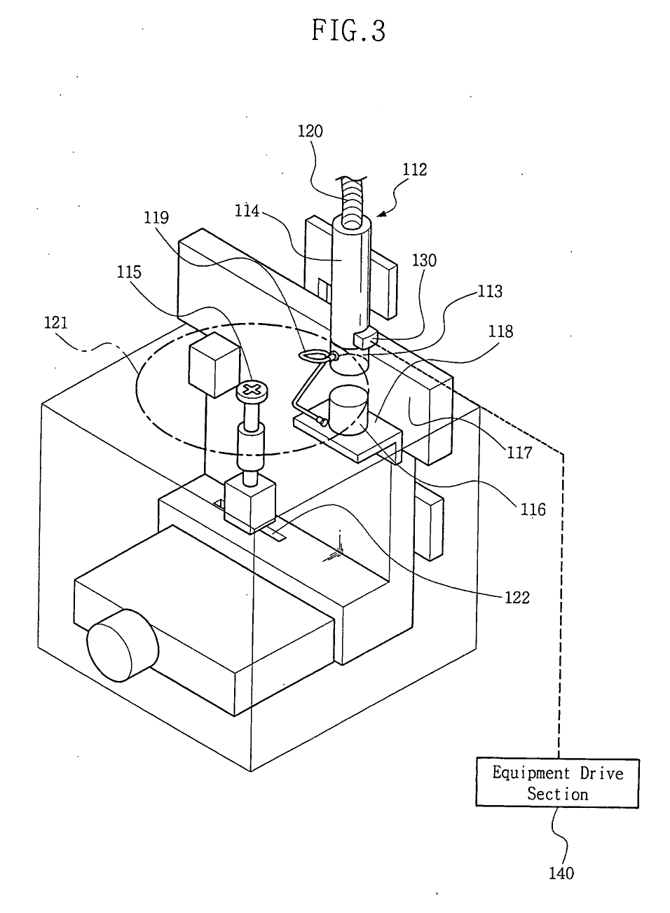

FIG. 3 is a perspective view illustrating one embodiment of a wafer edge exposure unit designed in accordance with the dictates of the invention.

Referring to FIG. 3, the exemplary wafer edge exposure unit comprises a wafer edge exposing device 112, a lens 113, a body tube 114, a support chuck 115, an illumination detector 116, a support wall 117, an illumination detector support member 118, an air device 119, an optical cable 120, a wafer 121, a horizontal adjustment device 122, an interlock generator 130, and an equipment drive stop section 140.

Body tube 114 is placed above an edge portion of wafer 121 once wafer 121 is fixed to support chuck 115 in edge exposing device 112. In one aspect, wafer edge exposing device 112 is structurally designed to expose the edge portion of wafer 121 to focused light directed to wafer 121 by body tube 114 in order to properly expose the edge portion of wafer 121 to thereby change its material characteristics for the reasons described above.

Lens 113 is disposed in body tube 114, receives light from lamp house 30 through an optical cable 120, and then transmits a focused version of the light on the edge portion of wafer 121.

Thus, the illustrated body tube 114 secures both wafer exposing device 112 and lens 113 in a single structural component. Body tube 114 may further function to shutter the light applied to the edge portion of wafer 121. Moreover, body tube 114 may also be adapted to move radially over wafer 121 to expose inner portions of the surface of wafer 121. Exposure of these inner wafer portions can present a challenge to this mechanical configuration, relative to its use in exposing the edge (e.g., circumferentially disposed) portions of wafer 121.

Wafer 121 is loaded on an upper portion of support chuck 115 in order to perform a wafer edge exposure process. Preferably, support chuck 115 is associated with a rotatable motor adapted to drive support chuck 115 in a manner that exposes the entire edge portion of wafer 121 to light emanating from body tube 114.

As light is emitted from tube body 114 towards wafer 121 and lower portions of the wafer edge exposure unit, illumination detector 116 receives and detects a portion of the light. Illumination detector is thus able to provide an indication of “measured light” in relation to the actual operating environment associated with the wafer edge exposure process.

Support wall 117, having a predetermined thickness, width, and height, is adapted to hold the attached illumination detector support member 118. Support wall 117 may also serve as a structural support for the wafer edge exposure unit generally.

Illumination detector support member 118 functions to support illumination detector 116. Since it is essential that illumination detector 116 remain fixed relative to the illumination detector support member 118, this component will general y have a flat upper surface. However, illumination detector 116 and illumination detector support member 118 may have any reasonable shape or configuration. For example, the other surfaces of illumination detector support member 118 may be formed by various shapes such as a triangular column shape and “L” shape.

Air device 119 is connected to body tube 114 and is generally adapted to remove (vacuum) particles arising from the handling of wafer 121.

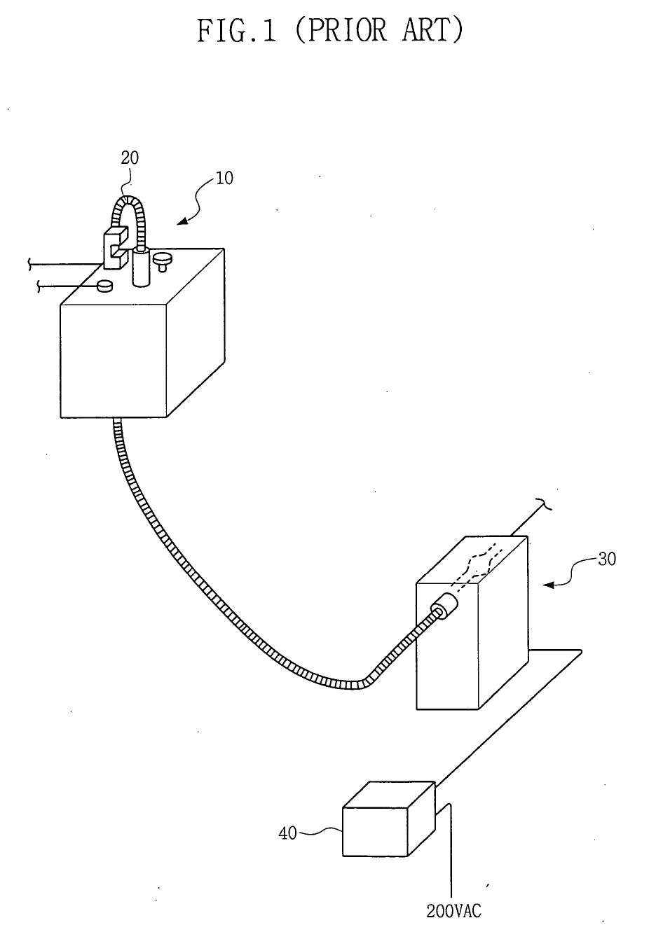

Optical cable 120 serves to transfer the light emitted from lamp house 30 (FIG. 1) to lens 113.

A horizontal adjustment device 122 may be formed on a vertical extension portion of support wall 117. It provides a path and mechanism that allows support chuck 115 to move as needed to position the edge portion of wafer 121 under body tube 114. Horizontal adjustment device 122 may be formed from a slotted groove, and a lower portion of support chuck 115 may be inserted into the groove, and adjusted therein. Horizontal adjustment device 122 may also be formed from a ball screw.

Interlock generator 130 is adapted to detect (e.g., measure) phenomenon (e.g., relative physical positions, orientations, alignment, mechanical impacts, respective clearances, particle contamination, etc.) in relation to wafer 121, as loaded onto support chuck 115, and in relation to body tube 114. Interlock generator 130 is further adapted to generates an interlock signal adapted to stop or preclude operation of the wafer edge exposure device when detected phenomenon are determined to be abnormal (i.e., outside established tolerances). For example, the interlock signal may be applied to an equipment drive section 140 to halt the rotation of support chuck 115.

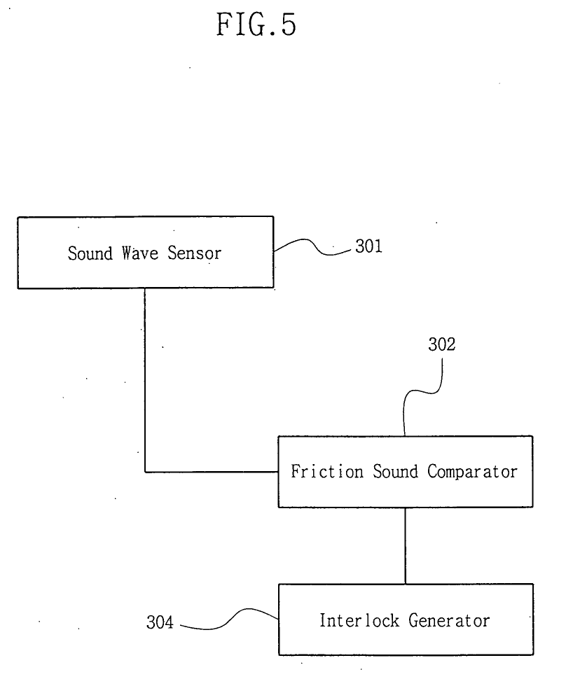

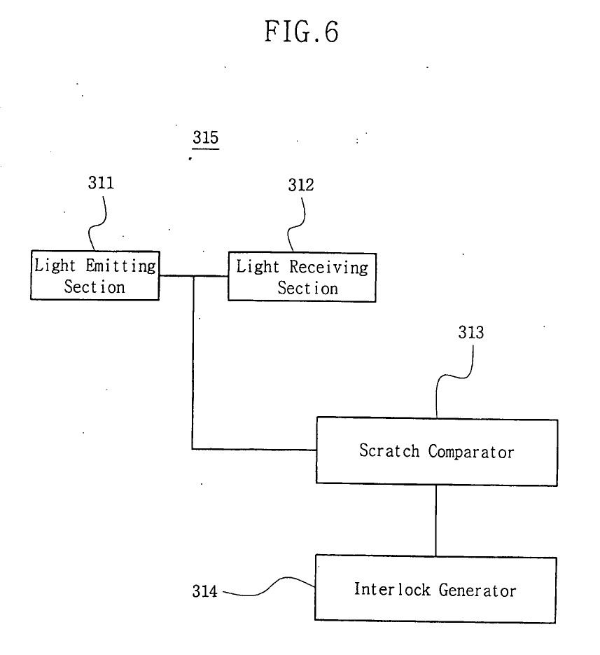

Detected phenomenon may be, for example, optical detection of a scratched wafer surface for wafer 121, particle detection of flying particles from wafer 121 caused by a damaging contact, and/or acoustic detection of mechanical friction (e.g., a rubbing noise). Regardless, of the exact nature of the detected phenomenon (and its associated detection mechanism) interlock generator 130 will generate the interlock signal based on the detection. Exemplary phenomenon detection processes will be described in some additional detail hereafter with reference to FIGS. 5 and 6.

Interlock generator 130 may, for example, be installed on a side of body tube 114 or other wise installed in the vicinity of body tube 114, such as a nearby point on support wall 117, or in relation to illumination detector 116. When thus positioned interlock generator 130 may accurately detect the desired phenomenon, such as friction noise or contact between wafer 121 and body tube 114.

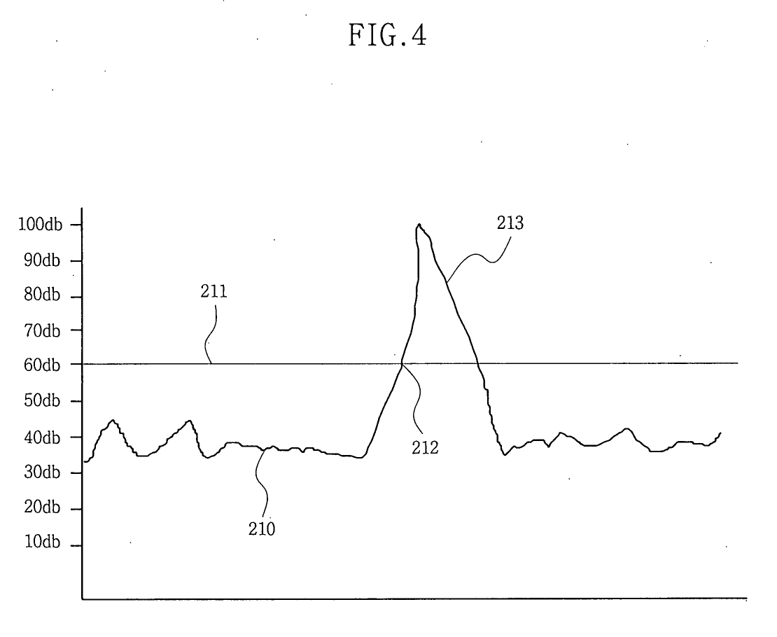

FIG. 4 is a graph plot showing an outcome result for one embodiment of the invention implementing an interlock generator based on friction noise detection and adapted for use in a wafer edge exposure unit like the one shown in FIG. 3.

The plot of measured sound resulting from a electrical output signal from interlock generator 130 includes several distinct sections; a normal detection section 210, an abnormal detection section 213 corresponding to a spike in detected friction noise, and a reference threshold 211. The detected acoustic spike 213 is related to contact between body tube 114 and wafer 121.

In the illustrated example, reference threshold 211 is set twenty to thirty dB higher than an expected ambient level of detected sound corresponding to normal operation of the wafer edge exposure apparatus. Such a set point precludes most false positive detections, yet provides a clear indication when the detected friction noise rises above 212 the reference threshold 211.

FIG. 5 is a block diagram illustrating one embodiment of an interlock generator adapted for use in the wafer edge exposure unit, such as the one illustrated in FIG. 3.

Referring to FIG. 5, a sound wave sensor 301 is coupled to a friction sound comparator 302, which is coupled to an interlock generator 304.

Sound wave sensor 301 conventionally detects sound in the vicinity of potential contact between wafer 121 and body tube 114 during a wafer edge exposure process. Sound wave sensor 301 converts the detected level of sound into an output electrical signal (digital or analog).

Friction sound comparator 302 is a conventionally designed circuit adapted to set a reference threshold and receive the electrical signal from sound wave sensor 301. The comparator circuit then compares received electrical signal to the reference threshold and outputs a comparison result. A digital value comparison between these two values may be easily obtained using conventional signal processing techniques and available comparison circuits.

The comparison result may be provided in digital or analog form, and may be provided as a flag or interrupt, or as a continuous signal. However, provided, when the comparison result exceeds the reference threshold, interlock generator 304 will generate the interlock signal.

FIG. 6 is a block diagram showing another embodiment of an interlock generator adapted for use in the wafer edge exposure unit, such as the one illustrated in FIG. 3.

With reference to FIG. 6, a scratch comparator 313 receives an image output signal from the operative combination of light emitting section 311 and light receiving section 312. The output of scratch comparator 313 is applied to interlock generator 314.

Light emitting section 311 and light receiving section 312 form a scratch measuring sensor 315 adapted to optically detect a scratch on the surface of a wafer, and generate a corresponding image output signal (digital or analog). Scratch comparator 313 compares the received image output signal with a stored reference image signal.

Within this exemplary configuration, light emitting section 311 irradiates wafer 121 with light having a desired wavelength. Thereafter, light receiving section 312 receives and detects reflected light from wafer 121. Using conventionally understood techniques, the reflected light from wafer 121 may be interrupted as contrast image data corresponding to the surface of the wafer, and this contrast image data may be used to distinguish scratched portions of the surface from unscratched portions of the surface.

The reference image signal (e.g., data) stored in comparator 313 will correspond to an unscratched wafer surface, and may thus be distinguished from a scratched surface. The comparison output from scratch comparator 313 may be similar to that of friction sound comparator above.

Referring to FIGS. 3 through 6, only the sound wave sensor 301 or scratch measuring sensor 315 need be installed in proximity to body tube 114, illumination detector 116, or illumination detector support member 118, for example. The remaining components may be conveniently located elsewhere.

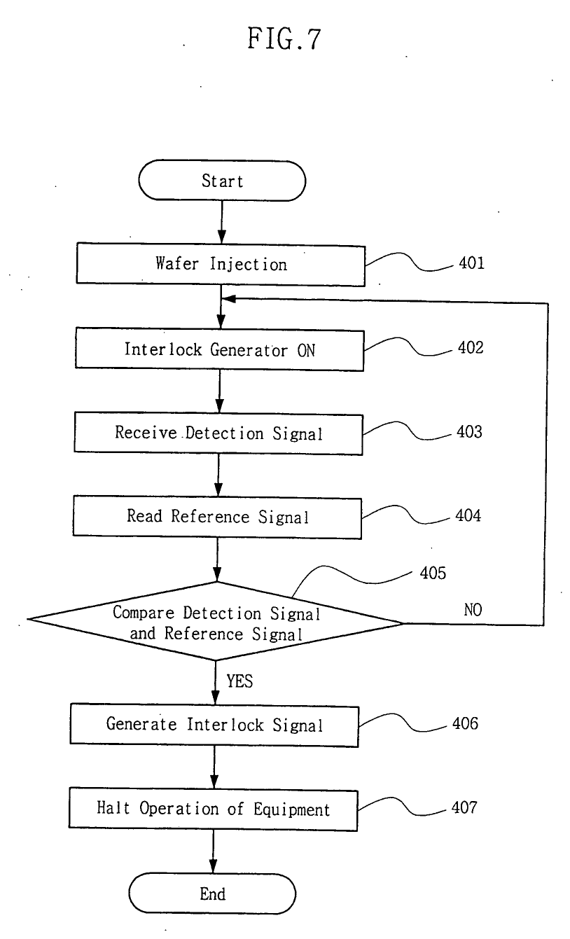

FIG. 7 is a flow chart illustrating an exemplary method of generating an interlock signal in a wafer edge exposure unit such as the one illustrated in FIG. 3.

Referring to FIG. 7, the method of generating an interlock signal comprises; injecting a wafer onto a support chuck (401), turning “ON” the interlock generator (402), receiving a detection signal (403), reading a reference threshold (404), comparing the detected signal with the reference threshold (450), upon determining that the detected signal exceeds the reference threshold, generating the interlock signal (406), and halting operation of the equipment (e.g., halting a drive section rotating the support chuck) (407).

Injection of a wafer onto the support chuck (401) may be accomplished by a human operator or a robotic apparatus, and then positioned, as needed, using the horizontally adjustment device to properly seat the wafer in the wafer exposing device. Either before or after the wafer has been moved into position within the wafer exposing device, the interlock generator is turned “ON” (402). Indeed, the interlock generator may be turned on when the wafer edge exposing device is first powered up.

Once a detecting or measuring section coupled to the interlock generator has detected, e.g., a scratch or elevated friction sound associated with the wafer, some corresponding indication of this detection or measurement (e.g., a data output signal) is passed to a comparator section (403). Operation of most comparator sections will involve reading a reference threshold established in view of the particular type of detection signal received (404).

If upon comparison the detection signal exceeds the reference threshold (405), the interlock signal is generated (406). Otherwise the operation loops back upon detected normal operation. As dictated by the specific design of the system the interlock signal interrupts (halts) operation (407).

In this manner, a method for monitoring possible abnormal states of operation for a wafer edge exposure apparatus may be provided. Any reasonable failure mode or abnormal phenomenon may be thus detected and responded to automatically. Exemplary abnormal states include friction noise or a scratched wafer surface. The particular detection technique (e.g., acoustic, optical, sensor-based, condition-based, proximity-related, etc.) used will be a function of the type of abnormality detected or measured.

In this regard, several exemplary embodiments of the invention have been described. However, it is understood that the wafer edge exposure apparatus of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

As described above, embodiments of the invention provide an exposure apparatus with an interlock generator. Accordingly, upon exposing the edge portion of a wafer to light while rotating the wafer on a support chuck, these embodiments have the effect of minimizing the quality wafer deterioration occurring upon contact of the wafer with, for example, a tube body.

What is claimed is:

1. A wafer edge exposure apparatus, comprising:
an edge exposing device adapted to expose an edge portion of a wafer loaded onto a rotatable support chuck under a body tube; and,
an interlock generator adapted to detect phenomenon in relation to at least one of the wafer and body tube, and further adapted to generate an interlock signal stopping operation of the wafer edge exposure apparatus upon detecting an abnormal phenomenon.

2. The wafer edge exposure of claim 1, wherein the abnormal phenomenon comprises a scratch in the surface of the wafer.

3. The wafer edge exposure apparatus of claim 2, further comprising:
an equipment drive section adapted to drive the support wafer and responsive to the interlock signal to halt operation.

4. The wafer edge exposure of claim 3, wherein the interlock generator optically detects the scratch.

5. The wafer edge exposure of claim 4, wherein the interlock generator comprising:
a scratch measuring sensor adapted to detect the scratch and generate a corresponding image output signal;
a scratch comparator receiving the image output signal and generating a comparator output;
wherein the interlock generator is responsive to the comparator output.

6. The wafer edge exposure apparatus of claim 5, wherein the scratch comparator stores a reference image signal, and wherein the comparator output is generated by comparing the image output signal and the reference image signal.

7. The wafer edge exposure apparatus of claim 6, wherein the scratch measuring sensor comprises:
a light emitting section irradiating the wafer with light; and
a light receiving section receiving and detecting reflected light from the wafer; and
wherein the image output signal corresponds to the reflected light.

8. The wafer edge exposure apparatus of claim 5, wherein the scratch measuring sensor is positioned proximate the body tube or the edge portion of the wafer.

9. The wafer edge exposure of claim 1, wherein the abnormal phenomenon comprises friction noise related to contact between the wafer and body tube.

10. The wafer edge exposure apparatus of claim 9, further comprising:
an equipment drive section adapted to drive the support wafer and responsive to the interlock signal to halt operation.

11. The wafer edge exposure of claim 10, wherein the interlock generator acoustically detects the friction noise.

12. The wafer edge exposure of claim 11, wherein the interlock generator comprising:
a sound wave sensor adapted to detect the friction noise and generate a corresponding output signal;
a friction sound comparator receiving the output signal and generating a comparator output;
wherein the interlock generator is responsive to the comparator output.

13. The wafer edge exposure apparatus of claim 12, wherein the friction sound comparator stores a reference threshold, and wherein the comparator output is generated by comparing the output signal and the reference threshold.

14. The wafer edge exposure apparatus of claim 13, wherein the sound wave sensor is positioned proximate the body tube or the edge portion of the wafer.

15. A method for monitoring abnormal operating phenomenon in a wafer edge exposure apparatus, comprising:
detecting abnormal phenomenon associated with a wafer loaded onto a support chuck under a body tube; and
generating an interlock signal halting operation of the wafer edge exposure apparatus in response to a detected abnormal phenomenon.

16. The method according to claim 15, wherein the wafer edge exposure apparatus comprises an equipment drive section adapted to drive the support wafer; and
wherein the method further comprises halting operation of the equipment drive section in responsive to the interlock signal.

17. The method according to claim 16, wherein the abnormal phenomenon relates to a friction noise associated with contact between the wafer and the abnormal phenomenon is detected acoustically.

18. The method according to claim 17, wherein acoustic detection of the abnormal phenomenon comprises:
detecting the friction noise using a sound wave sensor and generating a corresponding output signal;
receiving the output signal in a friction sound comparator, comparing the output signal to a reference threshold, and generating a comparator output;
wherein generation of the interlock signal is made in responsive to the comparator output.

19. The method according to claim 16, wherein the abnormal phenomenon is a scratch on a surface of the wafer and the abnormal phenomenon is detected optically.

20. The method of claim 19 wherein optical detection of the abnormal phenomenon comprises:
detecting a scratch on the wafer using a scratch measuring sensor and generating a corresponding output image signal;
receiving the output image signal in a scratch comparator, comparing the output image signal to a reference image signal, and generating a comparator output;
wherein generation of the interlock signal is made in responsive to the comparator output.
